(19) United States
(12) Patent Application Publication
(10) Pub. No.: US 2010/0038423 A1
(43) Pub. Date: Feb. 18, 2010

(54) RFID TERMINAL HAVING A PERSONAL AUTHENTIFICATION DEVICE

(75) Inventors: Suk Il Kim, Seoul (KR); Young Kwan Ju, Chungcheongbuk-do (KR)

Correspondence Address: CHRISTOPHER PAUL MITCHELL, 888 16TH ST., NW, SUITE 800, WASHINGTON, DC, 20006, US

(73) Assignee: JASON R & D, LTD., Cheongju (KR)

(21) Appl. No.: 12/443,441

(22) PCT Filed: Aug. 1, 2007
(86) PCT No.: PCT/KR2007/003703

§ 371 Date: Mar. 27, 2009

(30) Foreign Application Priority Data
Sep. 29, 2006 (KR) 20-2006-0026841

(51) Int. Cl. G06K 17/00

(52) U.S. Cl. 235/439

(57) ABSTRACT

The present invention relates to a Radio Frequency Identification (RFID) terminal equipped with personal authentication means, in which authentication means for performing personal authentication is further provided on the rear end of the body of the RFID terminal for performing customer authentication and payment, thereby enabling user authentication to be conveniently performing and preventing authentication information from being exposed to the outside. For this, the present invention provides an RFID terminal that includes a body, and a display unit and key input unit provided on the back of the outside of the body, and that reads information embedded in tags. The body is provided, at the rear end thereof, with personal authentication means for authenticating unique customer information.

### TECHNICAL FIELD

The present invention relates to a Radio Frequency Identification (RFID) terminal.

### BACKGROUND ART

The present invention relates generally to an RFID terminal, and, more particularly, to an RFID terminal equipped with personal authentication means, in which authentication means for performing personal authentication is provided on the rear end of the body of the RFID terminal for performing customer authentication and supporting payment, thereby enabling user authentication to be conveniently performed and preventing authentication information from being exposed to the outside.

Generally, RFID is wireless identification technology that wirelessly sends and processes specific information via radio frequencies using a small-sized semiconductor chip.

Conventional magnetic identification and barcode identification systems have a problem in that specific identifiable indications need to be marked on the outside of media, and thus the success rate of identification is lowered over time due to the weakening and attenuation of magnetic force. RFID is attracting attention as an alternative means that is capable of overcoming the above-described problem.

For this reason, Radio Frequency (RF) tags, to which RFID is applied, are applied to and used in various fields, such as a payment field, in which credit cards and traffic cards are used, a variety of automation businesses, distribution businesses, livestock management, entry control, attendance control, logistic management, and parking management.

FIG. 1 is a diagram showing the construction of an embodiment of a general RFID system. The general RFID system includes a RFID tag 110 for storing an ID and information (hereinafter referred to as a ‘tag’), an RFID terminal 120 for reading the information of the tag 110, and an information processing device 130 for processing the information of the tag 110 read through the RFID terminal 120.

In this case, the tag 110 and the RFID terminal 120 communicate with each other via a wireless connection, and the RFID terminal 120 and the information processing device 130 communicate with each other via a wired or wireless connection.

In general, the tag 110 is often referred to as a transponder, which is a compound word that is made up of a transmitter and a responder. The tag 110 includes memory, an Integrated Circuit (IC), a microprocessor, and an antenna.

Meanwhile, depending on the presence of an internal energy source, such a tag is referred to as a passive tag in the case where the energy source is present, or as an active tag in the case where the tag possesses the energy source.

The active tag can perform remote distance identification, compared to a passive tag, which is supplied with power in an induced current manner. In the case of the passive tag, the tag, which receives radio waves from a reader and is then activated, sends the ID or information thereof within a range in which the reader can read information, and the RFID terminal 120 receives the information through an antenna, and provides service through information processing, such as the transfer of the information to the information processing device or the comparison of the information with information in a database.

FIG. 2 is a front perspective view showing an example of an RFID terminal that is used when a tag is used as payment means. FIG. 3 is a block diagram showing the construction of the RFID terminal of FIG. 2.

Referring to the drawings, a general RFID terminal 200 includes an RFID tag reader module 230 provided inside a terminal body 210 and configured to send predetermined data to a tag 300 or detect signals sent from the tag 300, a key input unit 220, a display unit 240, a microcomputer 250, and a communication module configured to communicate with an access point 400.

Based on the above-described construction, the conventional RFID terminal reads customer information from a customer's RFID tag so as to process payment, and sends payment request signals, including the customer information, read from the tag, and payment amount information, input through the key input unit 220, to the access point 400 through the communication module 260.

Then, the access point 400 requests payment from a payment server, and the payment server determines the possibility of payment through a credit inquiry and a personal information inquiry, makes the payment, and sends the results of the payment to the access point.

Thereafter, the RFID terminal 200 receives the payment results from the access point 400 through the communication module 260, and displays the payment results on the display unit 240.

Meanwhile, in the payment system, user authentication may be performed by making a customer directly input a customer ID number through the key input unit 220 of the RFID terminal prior to a request for payment in order to prevent the illegitimate use of a tag.

Furthermore, since the shape and arrangement of the keypad of the key input unit 220, provided in the RFID terminal 200 to receive a payment amount, etc., are determined so as to increase the convenience of input work of an employee who manipulates the terminal, rather than a customer, the terminal must be directed toward and handed over to the customer so as to enable the customer to conveniently manipulate the key input unit 220 when receiving a customer ID number through the key input unit 220 to process customer authentication, with the result that there is a shortcoming in that manipulation is inconvenient.

Moreover, since a customer ID number must be input under the observation of a customer in the case where the customer ID number is input through the key input unit 220 of the RFID terminal 200, which is used by an employee, there is a shortcoming in that the customer ID number may be exposed to the employee.

### DISCLOSURE OF INVENTION TECHNICAL PROBLEM

Accordingly, the present invention has been made keeping in mind the above problems occurring in the prior art, and an object of the present invention is to provide an RFID terminal equipped with personal authentication means, in which a keypad for receiving customer ID numbers or biometric recognition means is provided to process user authentication on the rear end of the body of the RFID terminal for reading information from tags and performing user authentication and payment, thereby enabling user authentication to be conveniently performed and preventing authentication numbers from being exposed to other persons.

### Technical Solution

According to the present invention, a keypad, which is personal authentication means, is provided on the upper portion of the back of the body of an RFID terminal for reading information from tags and performing user authentication and payment, so that customers can easily manipulate the keypad disposed on the back of body while an employee holds the RFID terminal without requiring that the orientation of the body of the RFID terminal be changed, thereby providing an advantage of enabling the input of personal ID numbers and customer authentication to be conveniently performed.

Furthermore, according to the present invention, a blocking protrusion part is provided between the customer keypad and a display unit to prevent a process of customers inputting personal ID numbers using the keypad from being exposed to other persons, thereby providing an advantage of ensuring security.

According to the present invention, biometric recognition means for performing user authentication is provided on the upper portion of the back of the body of an RFID terminal for reading information from tags and performing user authentication and payment, so that customer authentication can be performed using unique personal biometric information without requiring the input of personal ID numbers, thereby providing an advantage of fundamentally preventing authentication numbers, such as personal ID numbers, from being exposed to the outside and thus improving security. Although the present invention will be described in conjunction with preferred embodiments with reference to the attached drawings, it will be apparent to those skilled in the art that various and obvious variations can be made based on the description without departing from the scope of the present invention. Accordingly, the scope of the present invention must be interpreted based on the accompanying claims, which are set forth so as to include such variations.

### Advantageous Effects

According to the present invention, a keypad, which is personal authentication means, is provided on the upper portion of the back of the body of an RFID terminal for reading information from tags and performing user authentication and payment, so that customers can easily manipulate the keypad disposed on the back of body while an employee holds the RFID terminal without requiring that the orientation of the body of the RFID terminal be changed, thereby providing an advantage of enabling the input of personal ID numbers and customer authentication to be conveniently performed.

Furthermore, according to the present invention, a blocking protrusion part is provided between the customer keypad and a display unit to prevent a process of customers inputting personal ID numbers using the keypad from being exposed to other persons, thereby providing an advantage of ensuring security.

According to the present invention, biometric recognition means for performing user authentication is provided on the upper portion of the back of the body of an RFID terminal for reading information from tags and performing user authentication and payment, so that customer authentication can be performed using unique personal biometric information without requiring the input of personal ID numbers, thereby providing an advantage of fundamentally preventing authentication numbers, such as personal ID numbers, from being exposed to the outside and thus improving security.

Although the present invention will be described in conjunction with preferred embodiments with reference to the attached drawings, it will be apparent to those skilled in the art that various and obvious variations can be made based on the description without departing from the scope of the present invention. Accordingly, the scope of the present invention must be interpreted based on the accompanying claims, which are set forth so as to include such variations.

### BRIEF DESCRIPTION OF THE DRAWINGS

FIG. 1 is a diagram showing the construction of an embodiment of a general RFID system;

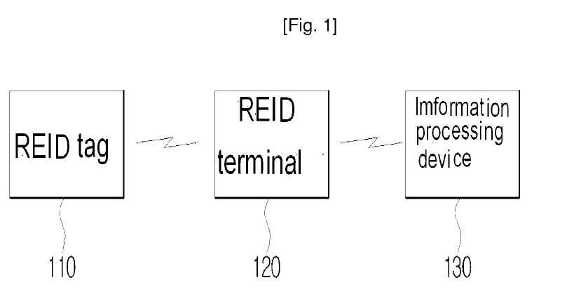

FIG. 2 is a front perspective view showing an example of an RFID terminal that is used when a tag is used for payment according to the prior art;

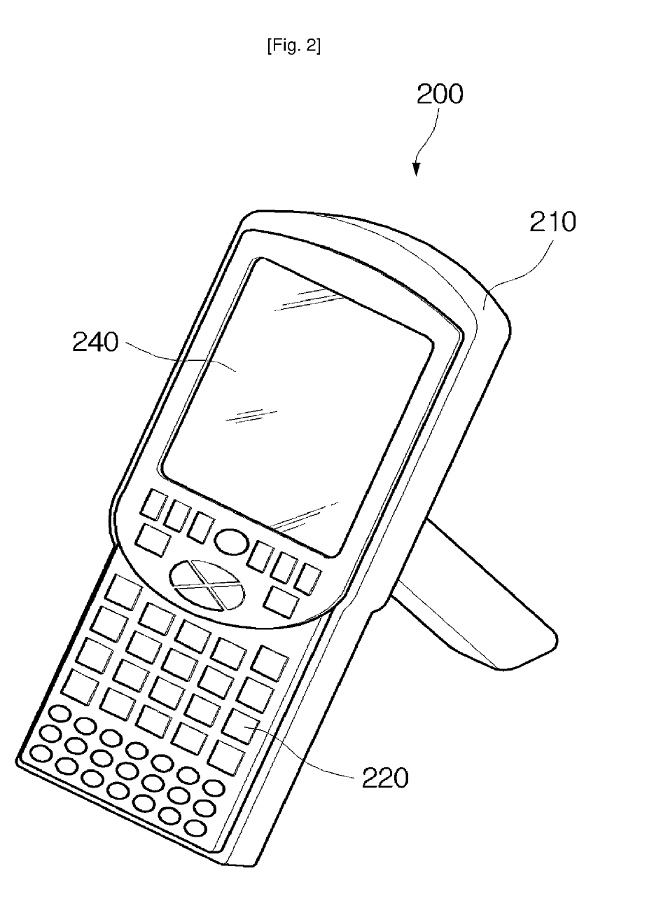

FIG. 3 is a block diagram showing the construction of the RFID terminal of FIG. 2;

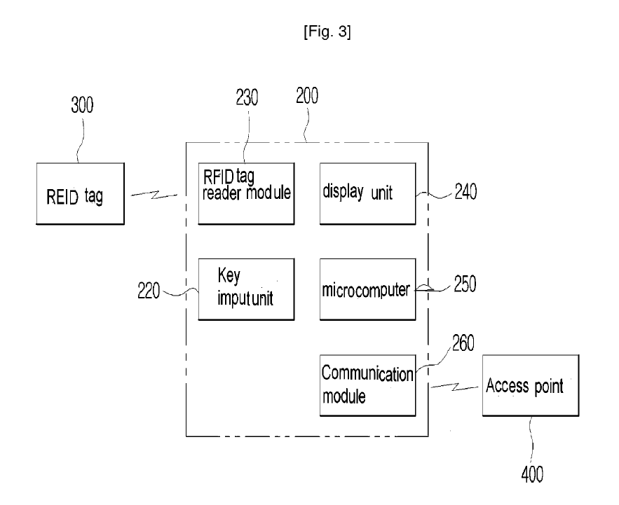

FIG. 4 is a front perspective view showing an example of an RFID terminal equipped with personal authentication means according to the present invention;

FIG. 5 is a partially cutaway side view showing an example of an RFID terminal equipped with personal authentication means according to the present invention;

FIG. 6 is a block diagram showing an RFID terminal equipped with personal authentication means (a keypad) according to a first embodiment of the present invention; and

FIG. 7 is a block diagram showing an RFID terminal equipped with personal authentication means according to a second embodiment of the present invention.

### DESCRIPTION OF REFERENCE NUMERALS OF PRINCIPAL ELEMENTS IN THE DRAWINGS

1: RFID terminal

11: RFID tag reader module

12: key input unit

13: display unit

14: personal authentication means

141:keypad

142: biometric recognition means

142a: fingerprint recognition means

142b: vein recognition means

15: microcomputer

16: communication module

17: body

18: customer display

19: blocking protrusion part

2: tag

3: access point

4: payment server

### BEST MODE FOR CARRYING OUT THE INVENTION

In order to overcome the above technical problem, the present invention provides an RFID terminal that includes a body, a display unit and key input unit provided on the back of the outside of the body, and that reads information embedded in tags. The body is provided, at the rear end thereof, with personal authentication means for authenticating unique customer information.

The personal authentication means may be formed of a keypad or biometric recognition means, and the biometric recognition means may be fingerprint recognition means, vein recognition means, or a combination thereof.

The present invention will become more apparent from preferred embodiments that will be described below with reference to the accompanying drawings. The present invention will be described in detail below through embodiments so that those skilled in the art can easily understand and reproduce the present invention.

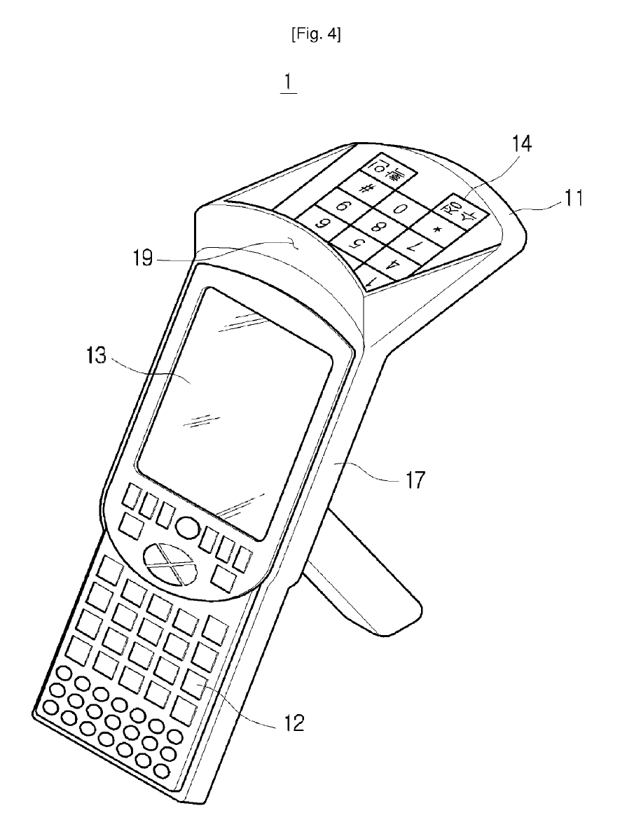

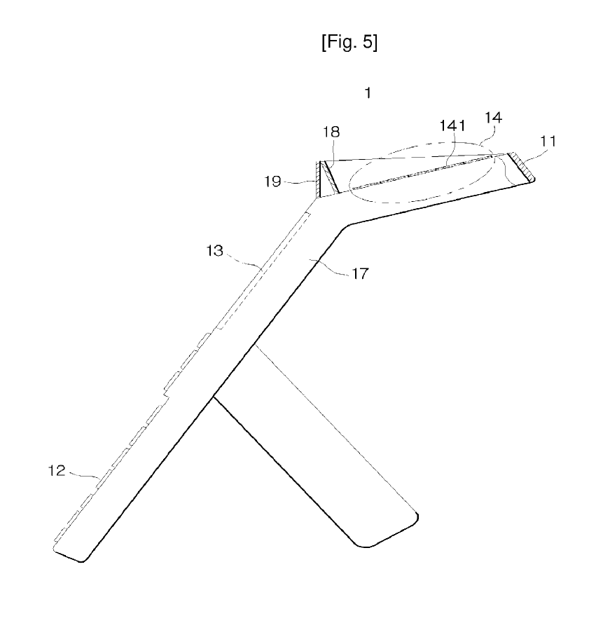

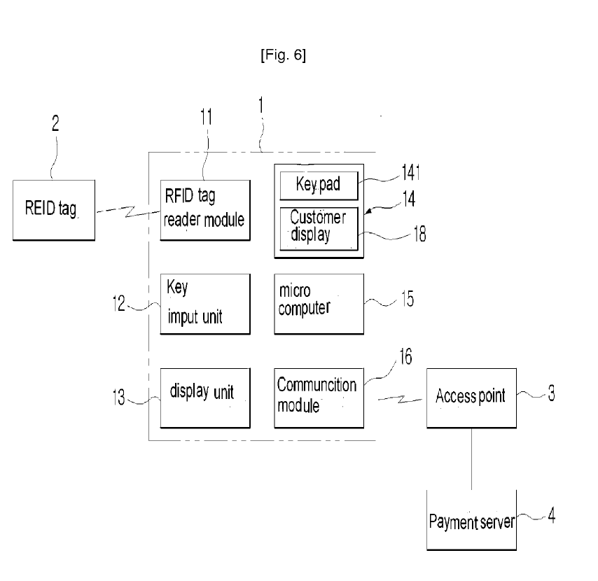

FIG. 4 is a perspective view showing an example of an RFID terminal equipped with personal authentication means according to the present invention. FIG. 5 is a partially cutaway side view showing an example of an RFID terminal equipped with personal authentication means according to the present invention. FIG. 6 is a block diagram showing an RFID terminal equipped with personal authentication means according to the present invention.

The RFID terminal of the present invention is a terminal that includes a body 17, an RFID tag reader module 11 provided inside the body 17 and configured to send predetermined data to the tag 2 or detect signals sent from the tag 2, a key input unit 12, a display unit 13, a microcomputer 15, and a communication module configured to perform data communication with an external access point 3, and that reads information embedded in the tag. The RFID terminal further includes personal authentication means 14 that is provided in the upper portion of the back of the body 17 to authenticate customer ID information according to the characteristic aspect of the present invention.

As shown in FIGS. 4 to 6, the personal authentication means 14 may be formed of a keypad 141 for receiving personal ID numbers.

As described above, the RFID terminal I equipped with personal authentication means according to the first embodiment of the present invention further includes the keypad 141, in addition to the key input unit 12 for manipulation by a terminal operator, so that customers can conveniently input personal ID numbers to perform customer authentication while an employee holds the terminal.

Furthermore, a blocking protrusion part 19 for shielding the manipulation of the keypad 141 from the view of other persons, including an employee., is formed, so that a process of inputting personal ID numbers is prevented from being exposed to other persons, and thus the exposure of the personal ID numbers for customer authentication can be prevented.

In the meantime, with regard to a personal ID number that is input by a customer, an asterisk (*) corresponding to each digit of the personal ID number may be displayed on the display unit 13 whenever the keypad 141 is manipulated, or a separate customer display 18 may be provided in the blocking protrusion part 17 to be exposed only to the customer, and asterisks (*) may be displayed on the customer display 18 during the input of the personal ID number by the customer.

It will be obvious that such a customer ID number for authentication has been previously stored in a payment server or registered with a credit information provider.

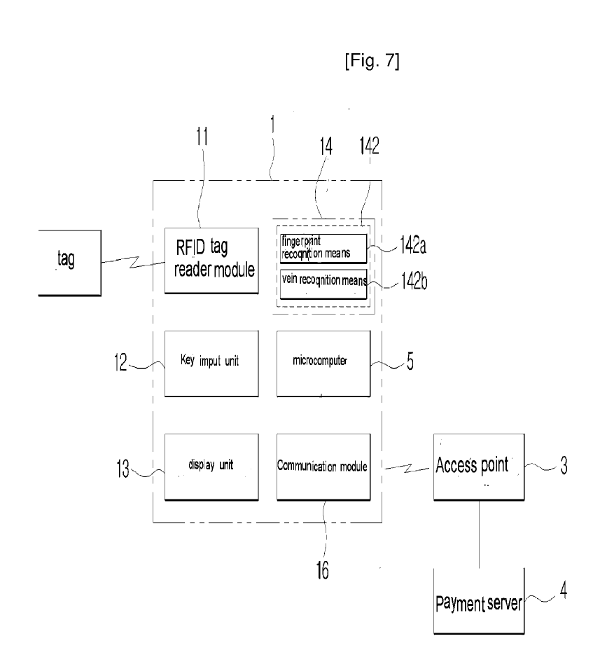

FIG. 7 is a block diagram showing an RFID terminal equipped with personal authentication means according to a second embodiment of the present invention. For a sectional view showing the external construction of the body, reference is made to FIGS. 4 and 5. Detailed descriptions of elements identical to those of the first embodiment are omitted below.

According to the second embodiment of the present invention, personal authentication means 14 provided in the back of a body 17 to authenticate unique customer information is further included, and the personal authentication means 14 is formed of biometric recognition means 142 for performing personal biometric identification.

According to the above-described present embodiment of the present invention, when a payment is requested using a tag, the payment is made after a customer's personal biometric information has been extracted using the biometric recognition means 142, the results of the extraction have been compared with previously stored data, and customer authentication has been performed, thereby preventing the illegitimate use of the tag.

In this case, the biometric recognition means 142 may be formed of fingerprint recognition means 142a. vein recognition means 142b, or a combination thereof. The microcomputer 15 functions to extract the features of a fingerprint and/or veins from a signal acquired through the biometric recognition means 142.

Meanwhile, in the case where the biometric recognition means 142 includes both the fingerprint recognition means 142a and the vein recognition means 142b, the key input unit 12 further includes a selection key for selecting a customer authentication method so that customer authentication is performed using either the fingerprint recognition means 142a or the vein recognition means 142b.

Since an identification system using the fingerprint recognition means 142a is used for systems for authenticating users by electronically reading fingerprints and comparing the read fingerprints with previously stored data, it is technology that is widely known in the biometric recognition field, even though it is inconvenient in that accurate images may not be recognized because users' hands have abnormalities or a scanner for receiving input has a problem.

The recognition technology using the fingerprint recognition means 142a is used to authenticate users by acquiring images of fingerprints, extracting minutiae from the acquired fingerprint images, comparing the extracted minutiae with previously stored customer information and performing matching, and includes a fingerprint sensor for sensing fingerprint images and outputting the fingerprint images to a microcomputer 15, even though this is not shown in the drawing.

In contrast, a recognition system using the vein recognition means 142b is used to recognize the shapes of the veins of the palm or wrist, and has advantages in that users' feeling of reluctance can be reduced and persons having no fingerprints or fingers can use it.

The recognition technology using the fingerprint recognition means 142a is used to authenticate a user based on the presence of a match by imaging veins while maximizing the brightness contrast of veins, extracting the pattern of veins, and comparing the extracted pattern of veins with previously stored patterns of veins.

For this purpose, although not shown in the drawing, the vein recognition means 142b includes an infrared illumination source, an infrared filter for passing infrared rays, radiated from the infrared illumination source and reflected from the palm or the back of the hand, therethrough while suppressing the passing of visible rays, and a camera for acquiring an image projected through the infrared filter. The camera may be a CCD or CMOS camera.

As a result, the RFID terminal equipped with personal authentication means according to the present invention is provided with both the fingerprint recognition means and the vein recognition means 142b, so that recognition can be accomplished using the vein recognition means 142b in the case where it is difficult to accomplish recognition using the fingerprint recognition means 142a, thereby effectively performing customer authentication.

The biometric recognition means is not limited to the fingerprint recognition means 142a or the vein recognition means 142b. Meanwhile, detailed technologies, such as interfaces through which signals are input from respective recognition means, are already well known, and thus descriptions thereof are omitted here.

In the meantime, it will be apparent that customer biometric information, which is used to be compared with minutiae extracted by the fingerprint recognition means 142a and the vein recognition means 142b, is already stored in the payment server 4 or registered with a credit information provider.

1. A Radio Frequency Identification (RFID) terminal equipped with personal authentication means, the RFID terminal including a body (17), and a display unit (13) and key input unit (12) provided on a back of an outside of the body (17), the RFID terminal reading information embedded in RFID tags, wherein: the body (17) is provided, at a rear end thereof, with personal authentication means (14) for authenticating unique customer information.

2. The RFID terminal as set forth in claim 1, wherein the personal authentication means (14) is a keypad (141) that is directed toward a customer to enable the customer to conveniently input a personal Identification (ID) number.

3. The RFID terminal as set forth in claim 2, wherein the body (1) is further provided, between the key input unit (12) and the keypad (141), with a blocking protrusion part (19) for shielding a process of inputting the personal ID number through manipulation of the keypad (141 ) to prevent the process from being exposed to another person.

4. The RFID terminal as set forth in claim 3, wherein the blocking protrusion part (19) is provided with a customer display (18) that displays an asterisk (*) whenever a digit is input through manipulation of the keypad (14).

5. The RFID terminal as set forth in claim 1, wherein the personal authentication means (14) is biometric recognition means (142) that performs personal biometric recognition.

6. The RFID terminal as set forth in claim 5, wherein the biometric recognition means (142) is fingerprint recognition means (142a).

7. The RFID terminal as set forth in claim 5, wherein the biometric recognition means (142) is vein recognition means (142b).

8. The RFID terminal as set forth in claim 5, wherein the biometric recognition means (142) is both fingerprint recognition means (142a) and vein recognition means (142b).
